(19) United States
(12) Patent Application Publication
(10) Pub. No.: US 2004/0248490 A1
(43) Pub. Date: Dec. 9, 2004

(54) Covering member and under-protector having the same

(75) Inventors: Hiromi Hyuga, Aichi-ken (JP); Daiichiro Kawashima, Aichi-ken (JP); Koji Nakao, Aichi-ken (JP); Takehiko Shiraki, Aichi-ken (JP)

Correspondence Address: POSZ & BETHARDS, PLC, 11250 ROGER BACON DRIVE, SUITE 10, RESTON, VA, 20190, US

(73) Assignee: TOYODA GOSEI CO., LTD.

(21) Appl. No.: 10/854,141

(22) Filed: May 27, 2004

(30) Foreign Application Priority Data
Jun. 3, 2003 (JP) 2003-158645

(51) Int. Cl. G11B 23/03

(52) U.S. Cl. 442/327

(57) ABSTRACT

A fender liner has a first black layer 22 and a second uncolored layer 23. The first layer 22 is formed of a nonwoven fabric in which binder fibers 25 are mutually fusion-bonded in a state that black main fibers 24 and the binder fibers 25 are mutually entangled. The surface of the nonwoven fabric has MIU of 0.16 or less, MMD of 0.02 or less, and SMD of 6.0 or less, when measured with a KES test method. The second layer 23 is formed of the nonwoven fabric in which the binder fibers 25 are mutually fusion-bonded in a state that regenerated fibers 28 made from scraps of air bags and the binder fibers 25 are mutually entangled.

### BACKGROUND OF THE INVENTION

The present invention relates to a covering member comprising a sheet-shaped molded component, and an under-protector having the covering member for covering a lower part of a body such as a tire house (wheel well) of a vehicle.

As for under-protectors of this kind, a fender liner is conventionally known, which is attached to the body of the vehicle such as an automobile along the outer surface of the tire house, and inhibits damage of components in the proximity of tires caused by scattering of muddy water and splash of small stones during traveling of the vehicle.

For the fender liner, a black-coloring or nearly black-coloring is generally used in consideration of the attached location on the vehicle. In recent years, for the purpose of absorbing a noise (a pattern noise) caused by contact between tires and the ground, and a collision noise produced when sands or small stones splashed by tires collide with the wall surface of the tire house, a fender liner provided with a nonwoven fabric has been developed and is practically used.

The nonwoven fabric in practical use has a single-layered structure using short fibers of, for instance, polyethylene terephthalate (PET). As for the steps of forming the nonwoven fabric, first, a pre-sheet is formed by heating PET short fibers with a high-melting point in a state of having resinous granular materials (pellets) with a low-melting point dispersed in the spaces of the short fibers. Then, the pre-sheet is press-molded into a three-dimensional shape while being heated again. During the molding, PET short fibers are mutually fusion-bonded through melted pellets. (See Japanese Laid-Open Patent Publication No. 2000-264255.)

A different fender liner which has been developed employs a nonwoven fabric shaped by mutually entangling main fibers comprising short fibers such as polyamide, with binder fibers comprising PET short fibers, and mutually fusion-bonding the binder fibers in the step of press-molding. For the purpose of inhibiting the absorption of muddy water in the non-woven fabric and the adhesion of dust on the non-woven fabric, the fender liner with the nonwoven fabric having the surface covered with a water resistant film, is also proposed. (See Japanese Laid-Open Patent Publication No. 2002-348767.)

By attaching the under-protector provided with these nonwoven fabrics along the outer surface of the tire house of the automobile, the above described pattern noise or collision noise is absorbed to reduce the transmission of the noise into the automobile.

The fender liner according to Japanese Laid-Open Patent Publication No. 2000-264255, incidentally, has a lot of fluffing of PET short fibers on the surface of the fender liner, of which most fuzz has a loop shape of which both ends are buried in the nonwoven fabric. As a result, there have been such problems that sands, dead leaves or twigs splashed by the rotation of tires, are easily held by the looped fuzz, and the appearance inside the tire house is easily deteriorated.

In addition, when coloring the fender liner to a predetermined color, it is conceivable to use a nonwoven fabric comprising the short fibers which have been previously colored to the predetermined color. However, in this case, there arises a need to color almost all of the short fibers composing the nonwoven fabric. It causes a problem of increasing a manufacturing cost for the fender liner.

It is also conceivable to color only the visible part of a fender liner from outside to a predetermined color with the use of a spray method, for instance. However, in this case, there is anxiety of increasing an amount of used paint because of covering irregularity of the paint, or absorption of the paint into spaces inside the nonwoven fabric, and of obstructing acoustic absorption because the spaces are filled with the paint.

Meanwhile, the fender liner according to Japanese Laid-Open Patent Publication No. 2002-348767 has greatly improved adhesion resistance to foreign materials such as sands, dead leaves or twigs due to the existence of a water resistant film. However, it needs a specially dedicated step in order to laminate the water resistant film on the surface of the nonwoven fabric.

### SUMMARY OF THE INVENTION

The present invention has been accomplished by paying attention to such problems as existing in prior arts. An object of the present invention is to provide a covering member which controls the increase of a manufacturing cost even for a material colored to a desired color, while having high foreign material adhesion resistance, and to provide an under-protector provided with the same.

In order to achieve the above object, one aspect of the present invention provides a covering member comprising a sheet-shaped molded component containing a nonwoven fabric having a plurality of entangled short fibers therein. A sheet-shaped molded component has at least one surface having the mean deviation of a surface roughness of 6.0 or less, when measured according to a KES test method for evaluating the texture of the surface of a nonwoven fabric.

Another aspect of the present invention provides an under-protector for covering a part of a vehicle body. The under-protector is made of a sheet-shaped molded component. The sheet-shaped molded component has at least one surface having the mean deviation of the surface roughness of 6.0 or less, when measured according to a KES test method for evaluating the texture of the surface of the nonwoven fabric.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a fragmentary side view showing a vehicle having a fender liner of a first embodiment mounted thereon;

FIG. 2 is a perspective view of the fender liner in FIG. 1;

FIG. 3 is an expanded sectional view schematically showing a cross section of the fender liner in FIG. 1;

FIG. 4(A) is an explanation drawing relating to a friction-measuring method for the fender liner in FIG. 1;

FIG. 4(B) is an explanation drawing relating to a roughness-measuring method for the fender liner in FIG. 1; and

FIG. 5 is an expanded sectional view schematically showing a cross section of the fender liner in a second embodiment.

### DETAILED DESCRIPTION OF THE PREFERRED EMBODIMENTS

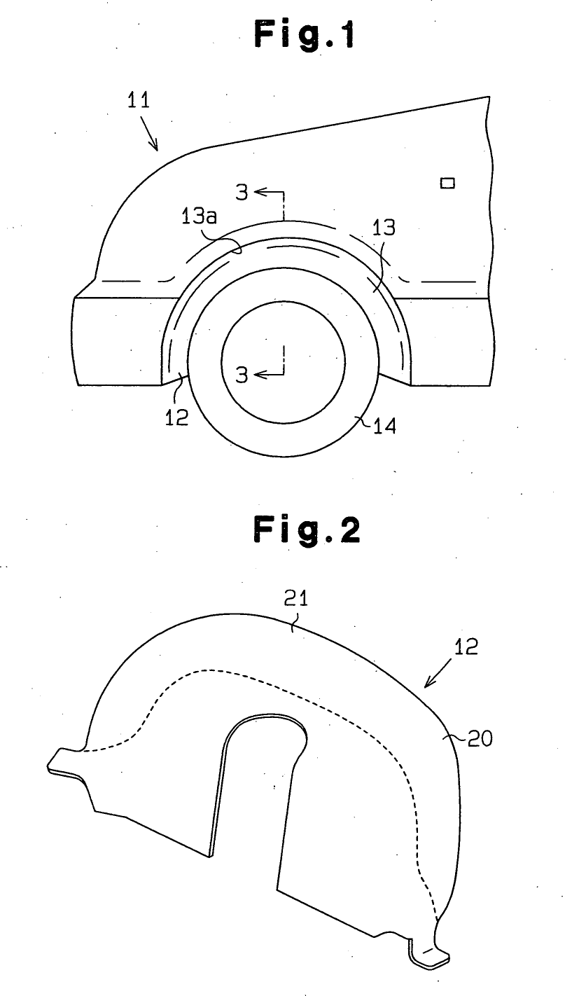

The first embodiment which applies an under-protector of the present invention to a fender liner, will be described below with reference to FIGS. 1 to 4.

As shown in FIG. 1, an automobile 11 has a fender liner 12 mounted on the outer surface 13a of a tire house 13 of the automobile 11, as an under-protector for covering the outer surface of the lower part of a vehicle body. The fender liner 12 inhibits the outer surface 13a of the tire house 13 from being damaged by small stones or mud splashed by tires 14 from the ground during traveling of the automobile 11. In addition, the fender liner 12 absorbs a noise such as a pattern noise caused by contact between the tires 14 and the ground during traveling of the automobile 11.

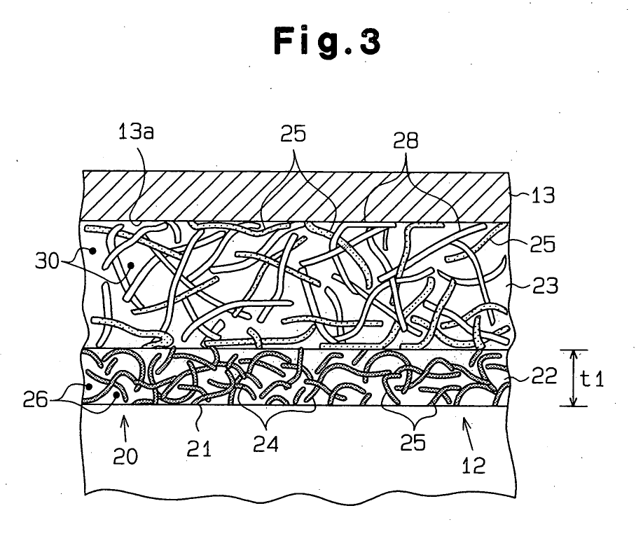

As shown in FIG. 2, the fender liner 12 is composed of a sheet-shaped covering member 20. The covering member 20 is formed into a shape complying with the outer surface 13a, when mounted on the outer surface 13a of the tire house 13. As shown in FIG. 3, the covering member 20 is composed of a sheet-shaped molded component 21.

In the present embodiment, the sheet-shaped molded component 21 to be used has a laminated structure having laminated several layers (two in the embodiment). The sheet-shaped molded component 21 has the first layer 22 located in a tire side in the tire house 13 and the second layer 23 located in a tire house side. Both of the first layer 22 and the second layer 23 are made of a nonwoven fabric, and are bonded to each other.

First, the first layer 22 will be explained.

The first layer 22 is composed of main fibers 24 of short fibers, and binder fibers 25 as fibrous binders made of synthetic fibers.

The first layer 22 is formed to have a network structure by fusion bonding of each binder fiber 25 in a state that the main fibers 24 and the binder fibers 25 are mutually entangled. More specifically, the first layer 22 has a plurality of cells 26 that are extremely fine spaces surrounded by the main fibers 24 and the binder fibers 25, and has an acoustic absorption effect mainly developed by the cells 26. The acoustic absorption effect is higher as the cell 26 is smaller in size and higher in number.

In addition, the first layer 22 and the second layer 23 are mutually bonded and fixed, by mutually entangling the main fibers 24 with the binder fibers 25 and regenerated fibers 28 in the proximity of their bonded sections, and fusion-bonding the binder fibers 25 together.

The main fibers 24 in the first layer 22 are composed of short fibers of polyethylene terephthalate (PET). In addition, a coloring agent such as carbon is applied to the outer surfaces of the main fibers 24, and the main fibers 24 are colored to black which is a predetermined color. On the other hand, binder fibers 25 are not colored and exhibit the color of a material itself. Accordingly, the first layer 22 shows black as a whole.

The diameters of main fibers 24 are preferably 10 to 50 μm in order to enhance working stability in a process of manufacturing the fender liner 12. If the fiber diameters of the main fibers 24 are smaller than 10 μm, there is an anxiety that the strength decreases. On the other hand, if the fiber diameters 24 of the main fibers are larger than 50 μm, a ratio of the main fibers 24 occupying in the whole first layer 22 is remarkably increased, which makes it difficult to form a plurality of fine cells 26 in the first layer.

Fiber lengths of the main fibers 24 are preferably short in a range of 10 to 100 mm, so as to enhance working stability in the process of manufacturing the fender liner 12. Furthermore, the main fibers are preferably mechanically crimped so as to form more fine cells 26.

On the other hand, the binder fibers 25 are composed of synthetic fibers made of a thermoplastic polymer having a melting point lower than those of main fibers 24 and regenerated fibers 28, or composite fibers (binary fibers) which have synthetic fiber cores and the thermoplastic polymer bonded on the surfaces of the synthetic fiber cores. For the thermoplastic polymer, easily available and inexpensive polyester fibers of PET or the like are most preferably used. Meanwhile, for the composite fiber, a core-in-sheath type or side-by-side type of the composite fiber is used. In addition, a fiber composing a core part of the composite fiber does not necessarily have a lower melting point than those of the main fibers 24 and the regenerated fibers 28, but preferably has rather a higher melting point than those of the main fibers 24 and the regenerated fibers 28.

For the binder fiber 25, because of having the capability of forming numerous cells 26 inside the first layer 22, a synthetic fiber made of a simple thermoplastic polymer is preferably used, which is easily formed finely. For the synthetic fiber, a polyester fiber superior in recyclability, particularly a PET fiber having a low melting point, is most preferably used.

The fiber diameters of the binder fibers 25 are preferably 10 to 50 μm in order to enhance working stability in the process of manufacturing the fender liner 12. If the fiber diameters of the binder fibers 25 are smaller than 10 μm, there is an anxiety that the strength decreases. In addition, there is an anxiety that in a step of forming the first layer 22, the binder fiber 25 is fused not to retain the form of a fiber and not to contribute to the formation of cells 26. Meanwhile, if the fiber diameters of the binder fibers 25 are larger than 50 μm, a ratio of the binder fibers 25 occupying in the whole first layer 22 is remarkably increased, which makes formed cells 26 fewer.

The melting point of the simple thermoplastic polymer is preferably 80 to 170° C., and is more preferably 100 to 170° C. If the simple thermoplastic polymer has a melting point of lower than 80° C., it has an anxiety to be softened by heat from the vehicle body and deform the fender liner 12, when the fender liner 12 is in a state of being mounted on the outer surface 13a of the tire house 13. Meanwhile, if the simple thermoplastic polymer has the melting point of higher than 170° C., it needs an increased amount of heat for bonding main fibers 24 through itself, in a step of forming the first layer 22 (the fender liner 12), and remarkably reduces the forming easiness.

In addition, the simple thermoplastic polymer has preferably the melting point lower than that of the main fibers 24 by 20° C. or more, and more preferably by 50° C. or more. If a difference of the melting points between the main fibers 24 and the thermoplastic polymer is less than 20° C., it is difficult to melt only the simple thermoplastic polymer in a step of forming the first layer 22 (fender liner 12), and it is impossible to form a network structure having a high acoustic absorption in the first layer 22.

The fiber lengths of the binder fibers 25 are preferably short in a range of 10 to 100 mm, so as to enhance the working stability in the process of manufacturing the fender liner 12. Furthermore, the binder fibers are preferably mechanically crimped to form more fine cells 26.

The thickness t1 of the first layer 22 shown in FIG. 3 is preferably in the range of 2 to 8 mm, more preferably in the range of 2 to 6 mm, and further preferably in the range of 2 to 4 mm. If the first layer 22 has the thickness t1 of less than 2 mm, an employment of the regenerated fibers 28, or a binder or the like which is non-tinted or is colored to an other color, for the second layer 23, makes it difficult to adjust the color tone of the surface of the fender liner 12, because one portion of those reaches to the proximity of the surface of the fender liner 12. Meanwhile, the first layer 22 having the thickness t1 of thicker than 8 mm increases an amount of used colored main fibers 24, which is not economical.

In addition, an amount of the binder fibers 25 contained in the first layer 22 is preferably in the range of 20 to 60 wt. %, and more preferably in the range of 20 to 50 wt. %. If the first layer 22 contains the binder fibers 25 of less than 20 wt. %, it cannot adequately keep the shape stability of the fender liner 12 formed into a three-dimensional shape. Meanwhile, if the first layer 22 contains the binder fiber 25 of more than 60 wt. %, it relatively reduces a content of the main fibers 24 having an important role for keeping the strength of the first layer 22, and cannot adequately enhance the strength and durability of the fender liner 12.

The second layer 23 will be explained.

The second layer 23 is composed of regenerated fibers 28 of short fibers, and binder fibers 25. The second layer 23 is formed by bonding and fixing the mutually entangled regenerated fibers 28 through mutual fusion of the binder fibers 25. In addition, the second layer 23 has a plurality of cells 30 formed inside, which are fine spaces surrounded by the regenerated fibers 28 and the binder fibers 25.

The regenerated fibers 28 are composed of polyamide (PA) fibers. In the present embodiment, the regenerated fibers 28 are made of polyamide such as nylon, formed of waste air-bags in an air-bag unit mounted on the automobile 11. In addition, in the present embodiment, a waste material includes discards of a base fabric for a material of the air bag and the scraps of air-bags produced when scrapping vehicles.

The fiber diameters of the regenerated fibers 28 are preferably 10 to 50 μm in order to enhance working stability in the process of manufacturing the fender liner 12. If the fiber diameters of the regenerated fibers 28 are smaller than 10 μm, there is an anxiety that the strength decreases. Meanwhile, if the fiber diameters of the regenerated fibers 28 are larger than 50 μm, a ratio of the regenerated fibers 28 occupying in the whole second layer 23 is remarkably increased, which reduces the number of cells 30.

The fiber lengths of the regenerated fibers 28 are preferably short in a range of 10 to 100 mm, so as to enhance working stability in the process of manufacturing the fender liner 12. Furthermore, the regenerated fibers are preferably mechanically crimped to form more fine cells 30.

In the present embodiment, the regenerated fibers 28 and the binder fibers 25 are not colored to the same color as the main fibers 24. More specifically, the regenerated fibers 28 show the color produced when the air bags have been made, or the color of the own material composing them, and the binder fibers 25 show the color of the own material composing them. Thus, the color of the whole second layer 23 is different from that of the first layer 22.

Subsequently, a method for manufacturing the sheet-shaped molded component 21 (the covering member 20) will be described below.

First, a first fiber mixture is formed, which contains the main fibers 24 and the binder fibers 25, and a second fiber mixture is formed, which contains the regenerated fibers 28 and the binder fibers 25. The first fiber mixture and the second fiber mixture are formed, for instance, by a method described below.

When forming the first fiber mixture, the binder fibers 25 are scattered to the main fibers 24 which have been previously colored to black and formed into floc, and the binder fibers 25 are dispersed in the main fibers 24. Subsequently, the main fibers 24 and the binder fibers 25 are mutually entangled by a needle punch. Meanwhile, when forming the second fiber mixture, first, scraps of air bags are disentangled with the use of a tool in a frog form into floc. Then, the binder fibers 25 are scattered on the flocculent scraps (the regenerated fibers 28) of the air bags, and the binder fibers 25 are dispersed in the regenerated fibers 28.

Thus formed first fiber mixture and second fiber mixture are stacked as shown in FIG. 3. Then, the stacked fiber mixtures are needle-punched. By the needle punching, fibers 24, 25 and 28 in the vicinity of bonded sections between the first fiber mixture and the second fiber mixture are mutually entangled.

Subsequently, the fiber mixture in such a state that the fibers 24, 25 and 28 in the vicinity of the bonded sections between the first fiber mixture and the second fiber mixture are mutually entangled, is preliminarily heat-treated. The preheating treatment is performed at a temperature equal to or higher than the melting point of the material composing the binder fibers 25 but lower than the melting point of the material composing the main fibers 24 and the regenerated fibers 28.

Then, the fiber mixture just after being preliminarily heat-treated, is cooled while being pressed in a mold of a press-molding machine, to make the sheet-shaped molded component 21 (the covering member 20) into a predetermined form. Through preheating treatment and cooling treatment, the binder fibers 25 are fused to each of main fibers 24 and regenerated fibers 28, to bond them. In the above step, the binder fibers 25 in the proximity of bonded sections between the first layer 22 and the second layer 23, are each fused to the main fibers 24 and regenerated fibers 28 in such a state that the main fibers 24, the binder fibers 25 and the regenerated fibers 28 are mutually entangled, and therefore both layers 22 and 23 are bonded and fixed. In addition, instead of preheating treatment, the fiber mixtures which have been needle-punched in the stacked state may be heated and cooled while being pressed in the mold of a press-molding machine.

The fender liner 12 is manufactured by cutting the sheet-shaped molded component 21 (the covering member 20) into a predetermined form. The fender liner 12 is attached to the inside of the tire house 13 so that the outer surface of the second layer 23 of the sheet-shaped molded component 21 adheres to the outer surface 13a of each tire house 13 of the automobile 11 while complying with the outer surface 13a. Namely, the fender liner 12 is mounted on the outer surface 13a of the tire house 13, in such a state that the first layer 22 of the sheet-shaped molded component 21 is arranged to face the tire 14. The fender liner 12 mounted on the outer surface 13a of the tire house 13 inhibits the outer surface 13a of the tire house 13 from being damaged by small stones or mud splashed by the rotation of the tire 14.

A method for evaluating the fender liner 12 as described above will be explained below.

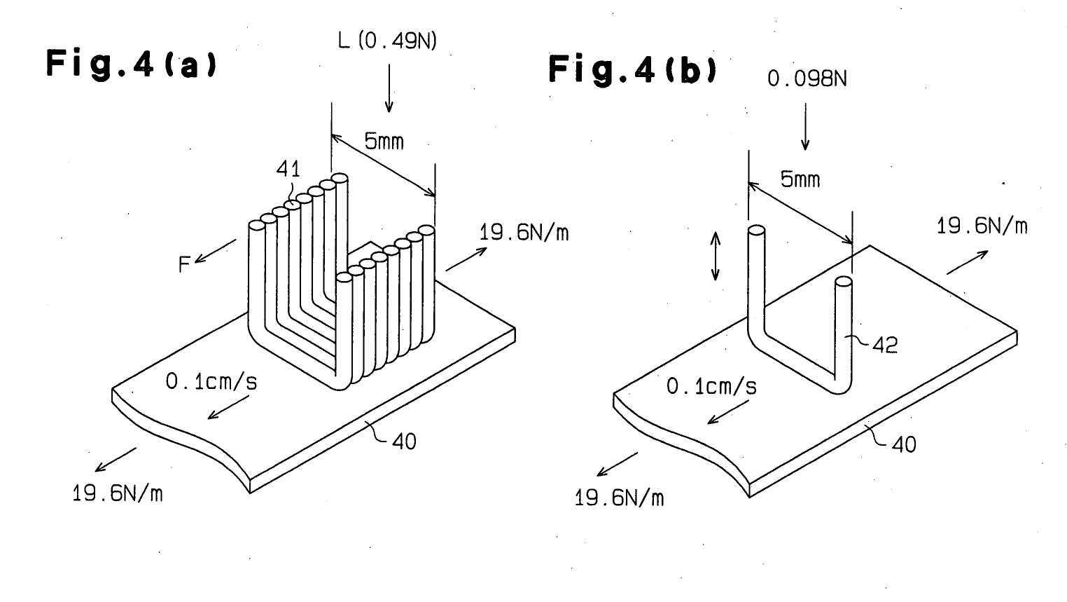

First, a substantially flat sample 40 with 20 cm square (see FIGS. 4(A) and (B)) is cut out from the formed fender liner 12. The surface condition of the first layer 22 in the sample 40 was evaluated by a surface-testing instrument KES-FB4 which is a KES (Kawabata's Evaluation System) instrument for evaluating the texture of a nonwoven fabric. The surface condition is evaluated by friction measurement and roughness measurement for the surface.

1) Friction Measurement

As shown in FIG. 4(A), a test probe 41 was prepared by bending piano wires each having a diameter of 0.5 mm so that a distance between free ends is 5 mm and both end portions extend parallel to each other, and bundling the ten bent piano wires together. Such test probe 41 is pressed to the sample 40 with a force of 0.49 N. The sample 40 is moved at a speed of 0.1 cm/s, and a tension of 19.6 N/m is applied to the sample 40 along the moving direction. Then, while the sample 40 moves for 2 cm, a frictional force F acting to the test probe 41 was measured, and a mean coefficient of friction (MIU) and a mean deviation (MMD) of a coefficient of friction were calculated from the measurement results. In addition, the frictional force F, a load L applied to the sample and the coefficient of friction μ have the following relationship. F=μL. According to the equation, the average coefficient of friction was calculated. The number of the used samples is ten. A method for calculating the mean deviation will be described below.

2) Roughness Measurement

As shown in FIG. 4(B), as a test probe 42, one piano wire was used. The piano wire has a diameter of 0.5 mm and is bent so as to control a distance between free ends to 5 mm and both end portions parallel to each other. The test probe 42 was pressed to the sample 40 with a force of 0.098 N. The sample is moved at a speed of 0.1 cm/s, and a tension of 19.6 N/m is applied to the sample 40 along the moving direction. The magnitude of the vertical motion of the test probe 42 was measured while the sample 40 moved for 2 cm, and the mean deviation of the surface roughness (SMD) was calculated from the measurement results. A method for calculating the mean deviation will be described below.

The fender liner 12 preferably has a value of the MIU of 0.16 or less, and more preferably 0.14 or less. In addition, a value of the MMD is preferably 0.02 or less, and more preferably 0.0185 or less. Furthermore, a value of the SMD is preferably 6.0 or less, more preferably 5.5 or less, and further preferably 5.0 or less. If the MIU exceeds 0.16, the MMD exceeds 0.02, and the SMD exceeds 6.0, respectively, the fluffing of the first layer 22 increases, and foreign materials such as sands, twigs, and dead leaves easily adhere to the first layer 22.

The samples of the fender liner 12 manufactured by the manufacturing method according to the present embodiment showed MIU of 0.14, MMD of 0.018, and SMD of 4.77. In contrast, the samples of conventionally composed fender liner having the surface of the tire side composed of short fibers and binder resins, which were manufactured by the method according to Japanese Laid-Open Patent Publication No. 2000-264255, showed MIU of 0.17 to 0.26, MMD of 0.020 to 0.030, and SMD of 6.26 to 10.14.

In addition, in the fender liner 12 of the present embodiment, the surface of the first layer 22 had only one or two fuzzes like whiskers per one square centimeter when observed with a microscope, and showed a smooth texture. In contrast, in the above conventionally composed fender liner, the surface of the first layer had about ten pieces of looped fuzzes per 1 square centimeter when observed with the microscope, and showed a rough texture.

In addition, the fender liner 12 in the present embodiment was mounted inside the tire house 13 located in one side of the automobile 11, the conventionally composed fender liner was mounted inside the tire house 13 located in the other side of the same automobile 11, which really ran for six months, and foreign-material adhesion resistance to the fender liner 12 was evaluated by visual observation. In the fender liner 12 of the present embodiment, the surface of the first layer 22 showed almost no adhesion of foreign materials such as sands, dead leaves and twigs. In contrast, in the above conventionally composed fender liner, the surface of the first layer 22 showed a considerable number of adhering foreign materials such as sands, dead leaves and twigs.

Thus, according to the present embodiment, the following effects can be obtained.

(1) The fender liner 12 is composed of the sheet-shaped molded component 21 made of the nonwoven fabric, and the surface of the first layer 22 of the sheet-shaped molded component 21 has SMD of 6.0 or less, MIU of 0.16 or less, and MMD of 0.02 or less, which are measured according to the KES test method.

Accordingly, the first layer 22 has reduced fluffing and improved smoothness on the surface. Thus, the fender liner 12 has improved adhesion resistance to foreign material such as sands, leaves and twigs, and keeps an appearance adequate.

(2) When the first layer 22 employs the nonwoven fabric formed by fusion-bonding mutually entangled main fibers by fusion of the binder resin such as granular PET, it is difficult to hold the uniformly mixed state of the main fibers with the binder resin for a long time, in the step of forming the pre-sheet of the nonwoven fabric. Accordingly, it is necessary to roll the mixture of the main fiber and the binder resin in mixed condition while heating it, to mutually fusion-bond the binder resins to some extent, and to make it into a sheet. In the above step of making the sheet, a part of the main fibers on the surface layer is caught by the roll and easily rises up to make a fluffy pre-sheet. Afterwards, even in a pressing step after preheating, the fuzz is hardly fused onto the surface of the sheet, and imparts the fluffy surface to the fender liner.

In contrast, in the fender liner 12 of the present embodiment, the surface of the first layer 22 is made of the nonwoven fabric in which mutually entangled main fibers 24 are bonded by mutual fusion of fibrous binder fibers 25 consisting of materials with the lower melting point than that of the main fibers 24. Consequently, the first layer 22 has preferable dispersibility of the binder fiber in the main fiber 24 in the step of press forming, and thus it is possible to make a stable pre-sheet by only needle-punching without heating in making the pre-sheet. Then, the pre-sheet is preliminarily heated, and is cooled in a state of being pressurized while being shaped in a press mold. Therefore, fluffing on the surface of the first layer 22 of the fender liner 12 can be particularly effectively controlled. Accordingly, the fender liner 12 can have a smoother surface of the first layer 22.

In addition, in the fender liner 12, the first layer 22 is formed of mutually entangled main fibers 24 and binder fibers 25, which are bonded together by fusion. Therefore, the first layer 22 can form a plurality of extremely fine cells 26 therein to enhance the acoustic absorption of the fender liner 12.

(3) In the fender liner 12, the sheet-shaped molded component 21 has a structure of the first layer 22 laminated with the second layer 23. Therefore, the first layer 22 and the second layer 23 can share functions, while imparting foreign material adhesion resistance to the first layer 22, and other functions to the second layer 23.

(4) In the fender liner 12, the second layer 23 invisible from outside is formed by using the regenerated fibers 28 which present a different color from the main fibers 24 in the first layer 22 that are colored black. In other words, in the fender liner 12, only the first layer 22 visible from the outside is colored black. Accordingly, even when the fender liner 12 has an increased thickness in order to improve serenity in a passenger compartment, it can avoid the increase of the quantity of the black-colored main fiber 24 to control the increase of the manufacturing cost.

(5) In the fender liner 12, staple fibers used in the second layer 23 include the regenerated fibers 28 formed of the scrap of air bags. Thus, an employment of the inexpensively available regenerated fibers 28 can further reduce the manufacturing cost for the fender liner 12, and also improves the recycability of waste air bags.

(6) Inside the fender liner 12, there exist a plurality of fine cells 26 and 30 among main fibers 24 or regenerated fibers 28, and binder fibers 25. Therefore, the fender liner efficiently absorbs noises occurring by contacts of tires with the ground, or collision noises occurring when sands and pebbles splashed by tires collide with the wall surface of the tire house 13, to enhance serenity in the passenger compartment.

(7) In the fender liner 12, the second layer 23 is bonded and fixed with the first layer 22, by mutually entangling the fibers 24, 25 and 28 and fusion-bonding binder fibers 25 with them, in the vicinity of bonding sections between both layers 22 and 23. Therefore, the first layer 22 and the second layer 23 can be hardly peeled from each other. Accordingly, the sheet-shaped molded component 21 has enhanced adhesion between both layers 22 and 23.

(8) In the fender liner 12, the first layer 22 and the second layer 23 employ the binder fibers 25 formed of the material with the lower melting point than that of the main fibers 24 or the regenerated fibers 28. Therefore, the sheet-shaped molded component 21 can be formed without heating the fiber mixture to reach melting points of materials composing the main fibers 24 and the regenerated fibers 28, which can reduce the manufacturing cost in molding the fender liner 12.

(9) In the fender liner 12, the first layer 22 and the second layer 23 employ the binder fibers 25 made of polyester fibers. Here, polyester fibers are easily formed to have decreased fiber diameters while the material is easily available and inexpensive. Thus, the first layer 22 and the second layer 23 can have extremely fine cells 26 and 30 easily formed therein, and preferably improve acoustic absorption for noises. Furthermore, the polyester fibers have an advantage of having a superior recycability.

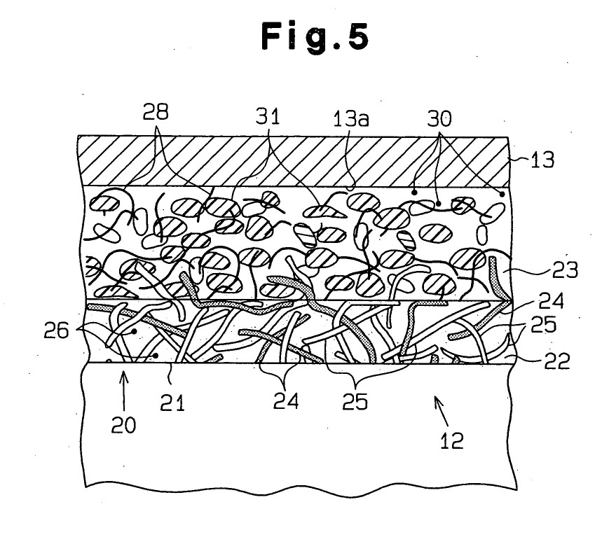

A second embodiment of the fender liner 12 according to the present invention will be explained with reference to FIG. 5. In the fender liner 12 of the second embodiment, the second layer 23 is composed of regenerated fibers 28 and binder resin particles 31, which is different from the structure of the first embodiment.

As shown in FIG. 5, the second layer 23 may include the binder resin particles 31 instead of the binder fibers 25, and have the structure of bonding mutually entangled regenerated fibers 28 by mutual fusion of each binder resin particle 31. In this case, the binder resin 31 in the second layer 23 is neither necessarily a resin colored to a predetermined color, nor a resin consisting of materials having a predetermined color.

The binder resin particles 31 are made of styrene based resins with lower melting points than the regenerated fibers 28, such as a hard styrene-butadiene rubber (SBR).

The melting point of the binder resin particles 31 is preferably 80 to 170° C., and more preferably 100 to 170° C. If the binder resin particles 31 have a melting point lower than 80° C., the fender liner 12 in the state of being mounted on the surface 13a of the tire house 13 has an anxiety of being deformed due to softening of the binder resin particles 31 by heat from the vehicle body. Meanwhile, if the binder resin particles 31 have a melting point exceeding 170° C., it needs a greater amount of heat for bonding the regenerated fibers 28 through the binder resin 31 in forming the second layer 23 (the fender liner 12). This remarkably decreases forming easiness.

The binder resin particles 31 preferably have the melting point lower than that of the regenerated fibers 28 by 20° C. or more, and more preferably by 50° C. or more. If the difference of the melting points between the regenerated fibers 28 and the binder resin particles 31 is less than 20° C., the binder resin particles 31 make it extremely difficult to melt only themselves in the step of forming the second layer 23 (the fender liner 12), and make it difficult to form the second layer 23 so as to have a network structure.

In addition, the sheet-shaped molded component 21 (the covering member 20) in the present embodiment, is manufactured, for instance, by the following method.

First, the first fiber mixture including the main fibers 24 and the binder fibers 25 used in the first layer 22, is formed by a needle-punching method, like in the first embodiment. Meanwhile, for the second fiber mixture used in the second layer 23, a pre-sheet with a sheet form is formed through mixing the regenerated fibers 28 and the binder resin particles 31 to uniformly disperse into a predetermined ratio in the state that the regenerated fibers 28 are entangled each other. Then, the pre-sheet is passed between heating rolls which have been heated to a temperature exceeding the fusing point of the binder resins 31 but lower than the melting point of the regenerated fibers 28, while a predetermined pressure is applied on rolls. Therefore, the regenerated fibers 28 are mutually fusion-bonded and entangled, and the binder resins 31 are impregnated into spaces among the regenerated fibers 28, to form a sheet for the layer of the tire house side.

Secondly, the first fiber mixture and the sheet for the layer of the tire house side are bonded and preheated. The preheating treatment is carried out at a temperature equal to or higher than the melting points of materials composing the binder fibers 25 and the binder resin 31, but lower than the melting points of the materials composing the main fibers 24 and the regenerated fibers 28.

Then, the conjugant including the first fiber mixture and the sheet for the layer of the tire house side just after being preheated, is cooled while being pressed in the mold of the press-molding machine, and is molded to a predetermined form of the sheet-shaped molded component 21 (the exterior material 20). Through preheating treatment and cooling treatment, the binder fibers 25 and the binder resin 31 are fusion-bonded, and the main fibers 24 and the regenerated fibers 28 are fixed. In the above step, the binder fibers 25 and the binder resin 31 in the vicinity of bonded sections between the first layer 22 and the second layer 23, go into gaps among the main fibers 24 and the regenerated fibers 28, to bond and fix both layers 22 and 23. In addition, instead of the preheating treatment, the conjugant may be heated and cooled while being pressed in the mold of the press-molding machine.

The fender liner 12 is manufactured by cutting thus press-molded component 21 (the exterior material 20) into a predetermined form. Although the surface of the second layer 23 shows recognizable fluffing in the fender liner 12 of the second embodiment, the surface of the first layer 22 develops smoothness substantially corresponding to the first embodiment.

Thus, the second embodiment provides following effects, in addition to the effects (1), (3) to (6), (8) and (9) described in the first embodiment.

(10) In the fender liner 12 of the second embodiment, the second layer 23 is formed by bonding mutually entangled regenerated fibers 28 with mutual fusion of binder resin particles 31. Therefore, the second layer 23 has many fine cells 30 formed therein, and can enhance the rigidity of the second layer itself, and consequently a sheet-shaped molded component 21 itself. Accordingly, the fender liner 12 can enhance its acoustic absorption, easily keeps itself to a desired form, and can improve attachability when being attached on the outer surface 13a of the tire house 13 of the automobile 11.

(11) In the fender liner 12, the second layer 23 uses a material made from styrene based resin as the binder resin 31. Accordingly, the second layer 23 is superior in strength, durability, oil resistance and the like.

It should be apparent to those skilled in the art that the present invention may be embodied in many other specific forms without departing from the spirit or scope of the invention. Particularly, it should be understood that the invention may be embodied in the following forms.

Although the binder fibers 25 of the first layer 22 are not colored but are made to show their own material color in each embodiment, it may be colored to a predetermined color such as black.

In each embodiment, the main fiber 24 of the first layer 22 is not limited to polyethylene terephthalate (PET) fiber. Also, the regenerated fibers 28 of the second layer 23 are not limited to polyamide (PA) fibers. These fibers 24 and 28 may be short fibers or mixed fibers obtained singly, for instance, from inorganic fibers such as aramid fibers, polyester fibers, vinylon fibers, polyolefin fibers, polyoxymethylene fibers, sulfone-based fibers, polyetheretherketone fibers, polyimide fibers, polyetherimide fibers, carbon fibers, glass fibers and ceramic fibers; cellulose fibers such as cotton and rayon; protein-based fibers such as silk and wool; or the mixture thereof.

In each embodiment, the regenerated fibers 28 of the second layer 23 are not limited to fibers made from scraps of air bags. The regenerated fibers 28 may be made from other scraps than the air bags, such as scraps of a woven fabric or a nonwoven fabric composing, for instance, the surface layer of a seat, a silencer, a floor mat, a floor carpet, a hood insulator and a dash outer insulator for vehicles. In such a case, the regenerated fibers 28 may show mixed various colors. In addition, the regenerated fibers 28 may be made from scraps of various resin-molded articles, for instance, interior materials, PET bottles or the like.

In each embodiment, the binder fibers 25 of the first layer 22 are not limited to materials made of polyester fibers. In addition, in the second embodiment, the binder resin particles 31 of the second layer 23 are not limited to a material made from styrene based resin. The binder fibers 25 and the binder resin particles 31 may be materials made of, for instance, polyethylen, polypropylene, polyamide, or the mixture thereof.

Although the binder resin particles 31 are used in the second embodiment, a powdery binder resin may be used instead.

In each embodiment, at least one of the main fibers 24 and the binder fibers 25 in the first layer 22 may be colored to other colors than black, such as a color close to black, for instance, gray.

In the first embodiment, the first fiber mixture of the first layer 22 and the second fiber mixture of the second layer 23 are individually needle-punched before they are overlapped in the step of molding the sheet-shaped molded component 21 (the exterior material 20), but the present invention is not limited to the order. When the sheet-shaped molded component 21 is molded, both of the first fiber mixture of the first layer 22 and the second fiber mixture of the second layer 23 may not be individually needle-punched before they are overlapped, but after they were overlapped, the overlapped fiber assemblies may be needle-punched.

In the latter order, fibers 24, 25 and 28 in each layer 22 and 23, and fibers 24, 25 and 28 in the vicinity of bonded sections between both layers 22 and 23 can be entangled at the same time.

In each embodiment, the sheet-shaped molded component 21 is not limited to a two-layer structure having the first layer 22 and the second layer 23. The present invention may provide a laminated structure in which three or more layers are laminated. In this case, the structure may have an adhesive layer including an adhesive or an adhesive film, arranged between fiber assemblies composing each layer, or have a water-repellent layer arranged between arbitrary fiber assemblies composing each layer. For instance, a rigidity-giving layer made from a resin plate or the like may be arranged.

In each embodiment, the structure may have, for instance, an adhesive layer made of an adhesive or an adhesive film arranged between fiber assemblies composing each layer, to bond each fiber mixture with the adhesive layer, or may have the fiber assemblies composing each layer stitched in an overlapped state, to bond and fix them.

In each embodiment, the configuration of the sheet-shaped molded component 21 is not limited to the entirely laminated structure. The sheet-shaped molded component 21 may be molded to have a partially laminated structure.

In each embodiment, the under-protector is embodied in the fender liner 12. In contrast, the under-protector according to the present invention may be embodied in, for instance, spats for reducing air resistance attached so as to project from the vicinity of the front edge of the tire house 13 in the front side, or a mudguard attached so as to similarly project from the vicinity of the rear edge of the tire house 13 in the front side. In addition, the under-protector according to the present invention may be embodied in, for instance, a quarter liner mounted on the front portion of the tire house 13 in the rear side, or a protector fuel cover mounted on the rear portion similarly of the tire house 13 in the rear side. In addition, the under-protector according to the present invention can be widely applied to components for covering at least a part of a lower part of the vehicle body, such as an air-dam skirt attached to a lower part of the front bumper, a side step attached to a lower part of the vehicle body, and an under-protector arranged so as to cover substantially all of lower parts of the vehicle body. In this case, the color of the under-protector is appropriately changeable, for instance, to a color corresponding to a body color of the automobile 11 by coloring at least one of the main fibers 24 and the binder fibers 25.

Therefore, the present examples and embodiments are to be considered as illustrative and not restrictive and the invention is not to be limited to the details given herein, but may be modified within the scope and equivalence of the appended claims.

1. An exterior material made of a sheet-shaped molded component including a nonwoven fabric in which a plurality of short fibers are entangled,
wherein the sheet-shaped molded component has at least one surface having a mean deviation of a surface roughness of 6.0 or less, when the surface roughness is measured according to a KES test method for evaluating the texture of the surface of the nonwoven fabric.

2. The exterior material according to claim 1, wherein the sheet-shaped molded component includes the nonwoven fabric which has the mutually entangled short fibers and binder fibers made of a material with a lower melting point than that of the short fibers, wherein the short fibers are mutually bonded by mutual fusion of each binder fiber.

3. The exterior material according to claim 1, wherein the sheet-shaped molded component has a laminated structure having several layers laminated.

4. The exterior material according to claim 3, wherein the sheet-shaped molded component has a first layer colored to a predetermined color and a second layer having a different color from that of the first layer.

5. The exterior material according to claim 1, wherein the short fibers include regenerated fibers made from scraps.

6. An under-protector for covering a part of a vehicle body,
wherein the under-protector is formed of a sheet-shaped molded component, and
wherein the sheet-shaped molded component (21) has at lest one surface having a mean deviation of a surface roughness of 6.0 or less, when the surface roughness is measured according to a KES test method for evaluating the texture of the surface of a nonwoven fabric.

7. The under-protector according to claim 6, wherein the under-protector is a fender liner, and the fender liner is formed along the outer surface of a tire house of a vehicle body and mounted on the outer surface of the tire house.

8. An exterior material made of a sheet-shaped molded component including a nonwoven fabric in which a plurality of short fibers are entangled,
wherein the sheet-shaped molded component includes the nonwoven fabric in which mutually entangled short fibers are bonded by mutual fusion of each fibrous binder made from a material with a lower melting point than that of the short fibers, and
the sheet-shaped molded component has at least one surface having an average coefficient of friction of 0.16 or less, when the coefficient of friction is measured according to a KES test method for evaluating the texture of the surface of the nonwoven fabric.

9. The exterior material according to claim 8, wherein the sheet-shaped molded component includes the nonwoven fabric which has the mutually entangled short fibers and binder fibers made from a material with a lower melting point than that of the short fibers, and wherein the short fibers are mutually bonded by mutual fusion of each binder fiber.

10. The exterior material according to claim 8, wherein the sheet-shaped molded component has a laminated structure having several layers laminated.

11. The exterior material according to claim 10, wherein the sheet-shaped molded component has a first layer colored to a predetermined color and a second layer having a different color from that of the first layer.

12. The exterior material according to claim 8, wherein the short fibers include regenerated fibers made from scraps.

13. An under-protector for covering a part of a vehicle body,
wherein the under-protector is formed of a sheet-shaped molded component,
wherein the sheet-shaped molded component includes a nonwoven fabric in which mutually entangled short fibers are bonded by mutual fusion of each fibrous binder made of a material with a lower melting point than that of the short fibers, and
wherein the sheet-shaped molded component has at least one surface having an average coefficient of friction of 0.16 or less, when the coefficient of friction is measured according to a KES test method for evaluating the texture of the surface of the nonwoven fabric.

14. The under-protector according to claim 13, wherein the under-protector is a fender liner, and the fender liner is formed along the outer surface of a tire house of a vehicle body and mounted on the outer surface of the tire house.

15. An exterior material made of a sheet-shaped molded component including a nonwoven fabric in which a plurality of short fibers are entangled,
wherein the sheet-shaped molded component includes the nonwoven fabric in which the mutually entangled short fibers are bonded by mutual fusion of each fibrous binder made from a material with a lower melting point than that of the short fibers, and
wherein the sheet-shaped molded component has at least one surface having a mean deviation of coefficient of friction in a value of 0.02 or less, when the coefficient of friction is measured according to a KES test method for evaluating the texture of the surface of the nonwoven fabric.

16. The exterior material according to claim 15, wherein the sheet-shaped molded component includes the nonwoven fabric which has the mutually entangled short fibers and binder fibers made from a material with a lower melting point than that of the short fibers, and wherein the short fibers are mutually bonded by mutual fusion of each binder fiber.

17. The exterior material according to claim 15, wherein the sheet-shaped molded component has a laminated structure having several layers laminated.

18. The exterior material according to claim 17, wherein the sheet-shaped molded component has a first layer colored to a predetermined color and a second layer having a different color from that of the first layer.

19. The exterior material according to claim 15, wherein the short fibers include regenerated fibers made from scraps.

20. An under-protector for covering a part of a vehicle body,
wherein the under-protector is formed of a sheet-shaped molded component, and
wherein the sheet-shaped molded component includes a nonwoven fabric in which mutually entangled short fibers are bonded by mutual fusion of each fibrous binder made of a material with a lower melting point than that of the short fibers, and
wherein the sheet-shaped molded component has at least one surface having a mean deviation of coefficient of friction in a value of 0.02 or less, when the coefficient of friction is measured according to a KES test method for evaluating the texture of the surface of the nonwoven fabric.

21. The under-protector according to claim 20, wherein the under-protector is a fender liner, and the fender liner is formed along the outer surface of a tire house of a vehicle body and mounted on the outer surface of the tire house.
